(19) United States
(12) Patent Application Publication
(10) Pub. No.: US 2025/0033939 A1
(43) Pub. Date: Jan. 30, 2025

(54) SCREW JACK SLEEVE WITH IMPROVED STOPPING CONFIGURATION

(71) Applicant: VENTRA GROUP, CO., Halifax (CA)

(72) Inventors: Helon RZHEVSKY, Vaughan (CA); Steven DEMOE, Cameron (CA); Murray DOBSON, Nobleton (CA)

(21) Appl. No.: 18/665,983

(22) Filed: May 16, 2024

Related U.S. Application Data
(60) Provisional application No. 63/516,007, filed on Jul. 27, 2023.

(51) Int. Cl. B66F 3/10; B66F 3/16

(52) U.S. Cl. CPC B66F 3/10; B66F 3/16

(57) ABSTRACT

A screw jack system with three (or more) stops that is capable of raising and lowering a substantially heavy load. Specifically, once the elevator sleeve travels through the case sleeve and is raised to its maximum height, the three (or more) inner stops of the elevator sleeve engage with the three (or more) outer stop channels of the case sleeve. These engagements are the stopping points of the screw jack which are the optimal points of support in order to prevent any lean from raising or lowering a heavy load or preventing any potential breaking points or sleeve pullout. Further, the screw jack system includes a pinion gear, drive gear, drive screw, elevator screw, and elevator tube that permit a user to covert rotational motion into linear motion in order to perform its desired raising and lowering functions.

### CROSS-REFERENCE TO RELATED APPLICATIONS

This application claims priority to U.S. Provisional Application No. 63/516,007, filed Jul. 27, 2023, the subject matter of which is incorporated herein by reference in its entirety.

### BACKGROUND

### Field of the Invention

The present invention relates to a screw jack for raising or lowering a vehicle. Specifically, the invention relates to a jack system using three (or more) engaged stops to provide substantial structural support in the vertical direction to stabilize jack due to off-center loading.

### Description of the Related Art

Generally, conventional jack systems are primarily utilized to lift a vehicle in order to change a tire. Historically, jack systems would engage with the bumper of the vehicle. However, jacks now have adapted to engage with other vehicle components, such as a vehicle's frame. This adaptation is attributed to contemporary, more light weight bumper design alterations that have been incorporated into most vehicles. The owner's manual for each specific vehicle will normally provide guidance with respect to jack points in order to safely lift the vehicle without risk of it falling off axis.

The three most popular vehicle frame-engaging jacks include the scissor jack, hydraulic jack, and the screw jack. The scissor jack is normally the least expensive and most portable jack; it normally comes with a handle in order to crank the jack, raising the vehicle as the user continues to wind it. The hydraulic jack may include a trolley base and a handle that is used to pump the jack and raise the vehicle. Lastly, the screw jack, which normally includes a base, vertical screws and sleeves, that rotate clockwise and counterclockwise in order to raise and lower the vehicle respectively. The screw jack is advantageous for its strength and reliability when raising heavier vehicles such as pick-up trucks, vans, and many more. Further, the screw jack does not require constant pressure, like the hydraulic jack, since it has self-locking functionality.

The primary concerns with respect to most screw jack systems relate to costs, safety, and effectiveness. It is a cost benefit for screw jacks to be as light weight as possible, especially with respect to screw jacks that are sold with a vehicle. Since fuel efficiency is a top priority for many automobile manufacturers, the lighter the vehicle, along with the jack inside, the easier it is to drive the vehicle forward by utilizing less fuel. The jack itself is a relatively small component of the vehicle weight, but vehicle manufacturers strive to reduce the weight of all parts, large or small, to reduce cumulative weight. However, there are some drawbacks with respect to a lightweight screw jack on account of its safety and overall effectiveness. For example, lightweight screw jacks must still have enough strength and the ability to lift the vehicle, which is more challenging when using less material. Thus, the desire to produce a screw jack that is low cost and lightweight should not come at the expense to the level of effectiveness and safeness in order to stably raise, hold, and lower a vehicle.

Furthermore, with respect to safety and effectiveness, many prior art screw jacks incorporate a base element that may produce a tilt if the user fails to use it properly and attempts to raise the vehicle on ground that is not flat and stable. As the jack potentially tries to adjust to counter the weight of the vehicle from moving, the jack may essentially break or fail, or the vehicle may even slide off the resting platform. This can prove to be dangerous, especially if a tire needs to be changed on a highway late at night when a user's vision may be impaired.

Additionally, prior art screw jack systems usually incorporate a screw assembly with a series of cylindrical screws and sleeves. As the screw is turned, a cylindrical inner tube will vertically slide within a cylindrical outer sleeve. This provides reinforcement and accounts for some tilt by counterbalancing when raising a vehicle or a load. Yet, some of the tubes and sleeves may be inclined to rotate relative to each other as the screw is cranked and thus, prevent the jack from raising the vehicle further. Some prior art screw jacks have developed a solution by incorporating keys and keyways in order to prevent such rotation from the tubes and sleeves. A key usually will jut out from the inner tube and ride a vertical keyway of the outer sleeve as the screw is turned in order to raise the vehicle. This prevents the rotation from occurring. Yet, these keys and keyways are still susceptible to distortion and breakage if under high stress conditions such as heavy weight or a ground that is not flat.

Certain prior art screw jacks also use a drive screw that is perpendicular to a drive gear to convert rotational motion into linear motion. However, if the vehicle shifts as it is being raised, it can cause a component of the loading to be off axis with respect to the vertical direction. This could cause substantial stress to be applied to the connection between the drive screw and the drive gear, and particularly produce a bending moment at the connection. If the sleeves are not fully extended relative to one another, because their walls are engaged by substantial axial overlapping, they provide added support against such off-axis loading. But, if the sleeves are fully extended, this could prove to be an issue since the force may cause the sleeves to separate.

Lastly, FIG. 7 is a screw jack design with a single stop mechanism. The stop mechanism provides some resistance in the event of an off-axis loading. However, a single stop mechanism only provides support in a single direction and thus, a breaking point among the screw jack's internal mechanisms may still occur. Additionally, in that design the stop is created by a deformed or lanced portion from the upper edge of the lower tube, which means only a small nominal length between each internal sleeve can be engaged as depicted in FIG. 8. Such a marginal amount of nominal length is insufficient to provide enough surface area contact among the screw jack's internal sleeves to prevent the screw jack from reaching a potential breaking point when a load is off axis and/or too heavy to support. The primary resistance is provided by the single stop, but it can only resist angular deflection in one general direction.

Therefore, the inventors have endeavored to develop a screw jack that is light weight, inexpensive, stable, and safe to provide the substantial support desirable to prevent a potential breakage point among the screw jack's internal mechanisms (i.e., drive gear, drive screw, cylindrical tubes, and sleeves).

### SUMMARY

The present disclosure relates to a screw jack system comprising a base, a case body with a drive gear to provide rotational motion, a rotational input for driving the drive gear, a drive screw perpendicular to the drive gear and rotatable therewith to convert rotational motion into linear motion. The screw jack system also comprises a plurality of telescoping sleeves extendible and retractable relative to one another to permit vertical elevation, a raising and lowering mechanism within the sleeves for extending and lowering comprising an internally threaded shaft meshed with the drive screw such that rotation of the drive screw raises and lowers the internally threaded shaft linearly to extend and retract the sleeves relative to one another. At the bottom, first one of the sleeves is connected to the base, upper portion of the bottom, first one case sleeve and a lower portion of a second one of the case sleeves telescopingly received in the bottom, first one each have at least three stop mechanisms configured to engage one another on at least three locations when said second sleeve is fully extended with respect to the bottom, first sleeve to retain the second case sleeve against withdrawal from the first case sleeve. A load rest is affixed atop the plurality of case sleeves for engagement under a vehicle or a load.

The present invention accounts for any off axis loading in the event that the vehicle starts to shift when it is being raised. Unlike the prior art, when the sleeves incorporated in the present disclosure are fully extended, the three (or more) engaged stops between the bottom case sleeve and the second elevator sleeve provide the added support against off-center loading. The use of three or more stops is particularly advantageous for vehicles, as often tire changes are performed on less-than-optimal surfaces, often roadside shoulders and the like. Thus, the vehicle shifting may be in any direction as jacks are typically used near one corner of the vehicle (which means lateral shifting or fore-aft shifting are both possibilities). The use of three (or more) engaged stops provides support in multiple directions against off-center loading.

Other aspects, features, and advantages of the present disclosure will become apparent from the following detailed description, the accompanying drawings, and the appended claims.

### BRIEF DESCRIPTION OF THE DRAWINGS

An exemplary embodiment of the invention will now be described with reference to the accompanying drawings, in which:

FIG. 1 is a sectional side elevational view showing all components of the screw jack.

FIG. 2 is an exploded perspective view of the components of the screw jack sleeves with three stops;

FIG. 3 is a top, cross-sectional view of the screw jack sleeve with three stops that depicts each stop mechanism and their respective stop channels;

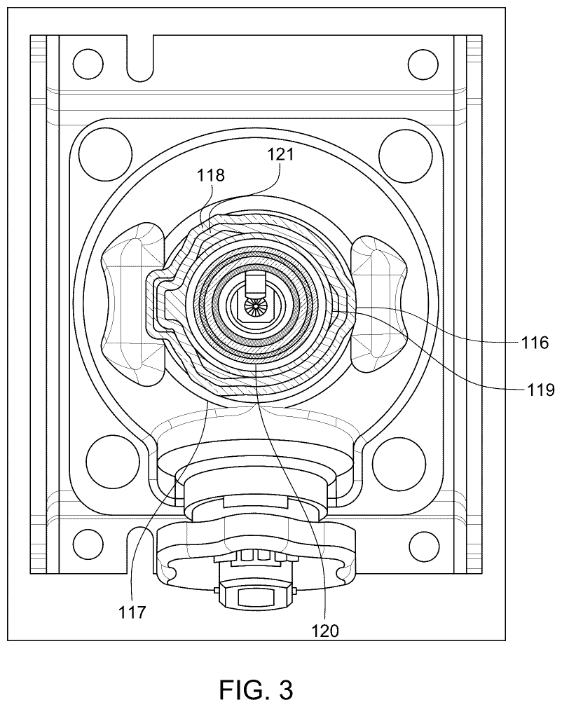

FIG. 4 is a side view of the of the screw jack sleeve with three stops in its retracted position;

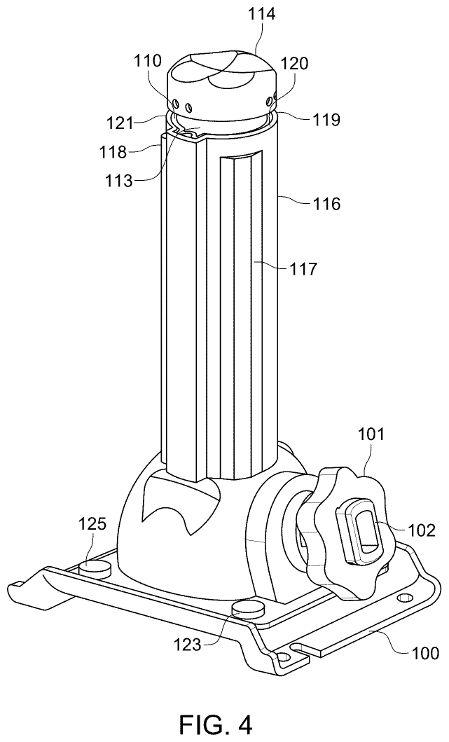

FIG. 5 is a side view of the of the screw jack sleeve with three stops in its fully extended position;

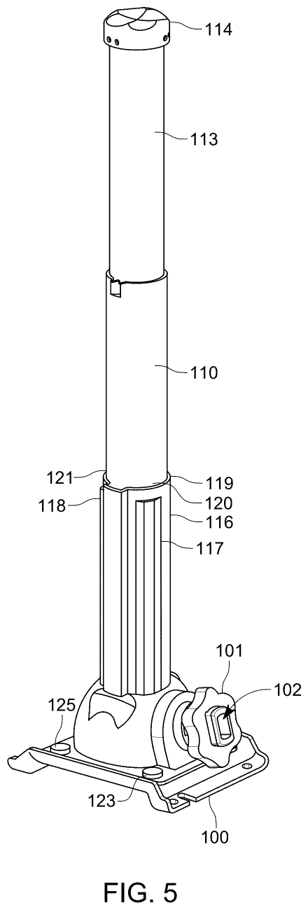

FIG. 6 is a side, cross sectional view of a prior art screw jack sleeve with only one stop;

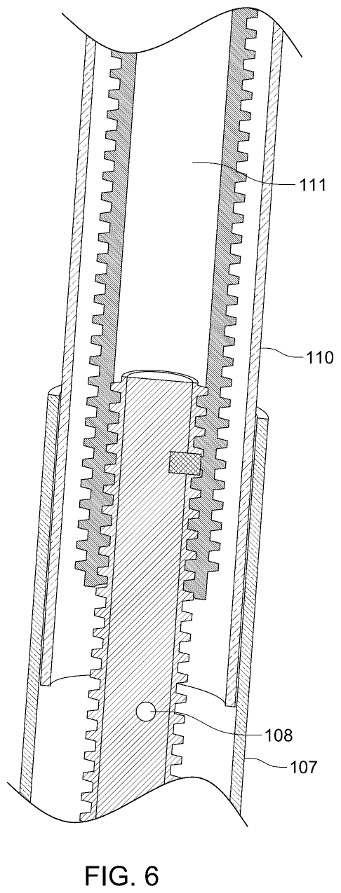

FIG. 7 is a side view of a prior art screw jack's elevator sleeve and case sleeve with only one stop design; and

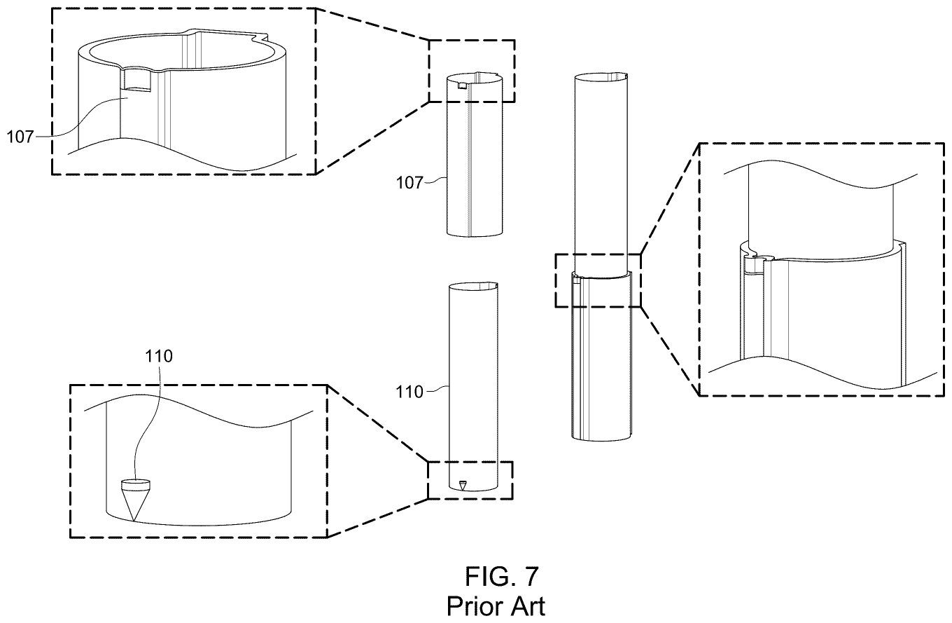

FIG. 8 is a juxtaposition of a prior art screw jack sleeve with only one stop design and screw jack sleeve with three stops that displays the nominal lengths between each design's respective case sleeve and elevator sleeve.

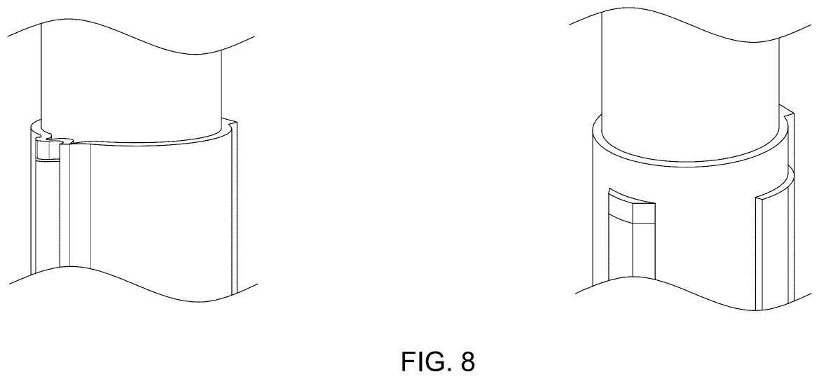

### DETAILED DESCRIPTION OF THE DRAWINGS

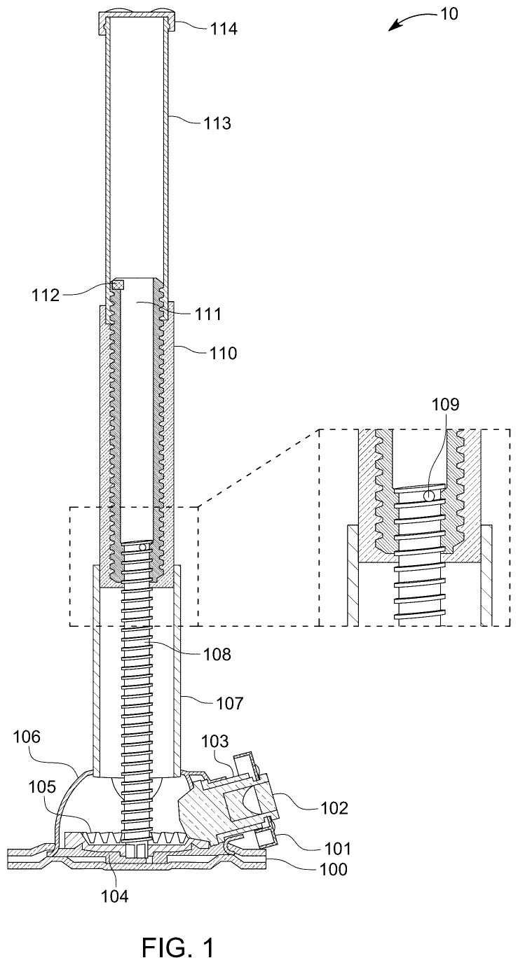

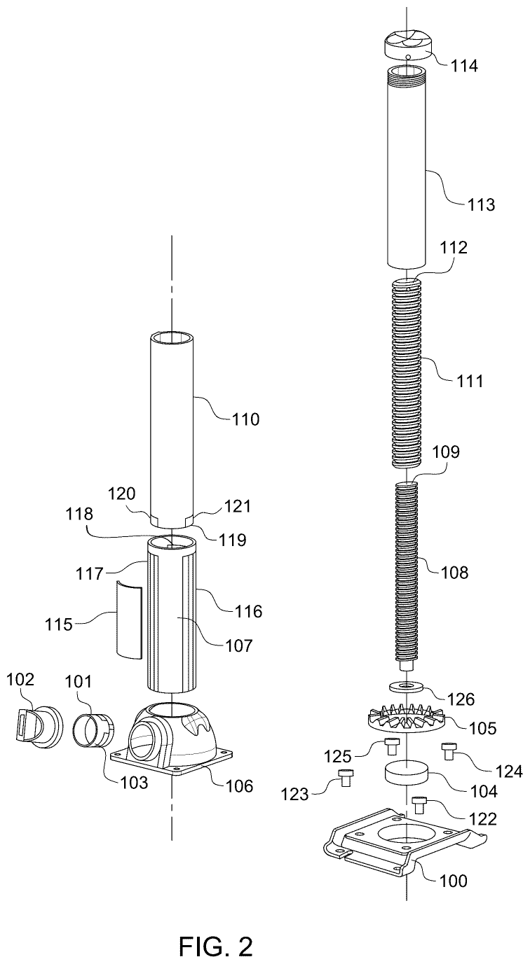

The screw jack sleeves with three stops 10, to be hereinafter described in more detail with references to FIGS. 1 to 2, is shown in FIG. 1 mounted on a base 100 that can be planted upon a surface to provide stability and support.

The case 106 rests on top of the base 100 and houses the components that convert rotational motion into linear motion. The case 106 is tightly affixed on top of the base 100 using a suitable fastening, such as a series of four case rivets comprised of the first case rivet 122, second case rivet 123, third case rivet 124, and fourth case rivet 125. Starting from the bottom of the base is a thrust washer or ball bearing 104, a drive gear 105, and drive gear washer 126 that lay horizontal and flat to produce the rotational motion as the drive gear 105 is turned in a clockwise direction. The drive gear's 105 axis is oriented vertically. The pinion gear 102 is rotated about an axis that is horizontal or angled closer to horizontal, and it is housed within a pinion bushing 103 that can be rotated as the user turns the pinion knob 101 (collectively the rotational input) clockwise. For example, as the user turns the pinion knob 101 clockwise, the screw jack advances to its raising position. Next, the user can use the appropriate tools to engage with the rotational input in order for the pinion gear 102 to turn and engage with the drive gear 105. The intermeshed gear teeth then rotate clockwise about its vertical axis to engage with the drive screw 108 in order to produce the overall linear motion.

The drive screw 108 is housed within both the case 106 and the vertically elongated case sleeve 107, which acts as the bottom, first sleeve. The drive screw 108 is externally threaded and the elevator screw 111 is internally threaded at the lower portion thereof, with the threads interengaging.

The elevator screw 111 is also externally threaded along its length and the elevator tube 113 is internally threaded at a lower portion thereof, with the threads interengaged. As the drive screw 108 rotates (clockwise), the drive screw 108 initially rotates the elevator screw 111. Rotation of the elevator screw 111 in the clockwise (raising) direction in turn causes the elevator tube 113 to travel vertically, upwardly along the rotational axis to a fully extended position (shown in FIG. 1). As the elevator tube 113 is raised, it pulls the elevator sleeve 110 along with it, telescopingly. When the elevator tube 113 is fully extended relative to the elevator screw 111, the elevator screw pin 112 inserted or formed at top of the elevator screw 111 stops further relative rotation between the elevator screw 111 and the elevator tube 113. The elevator tube 113 has a key extending from the lower end thereof that rides inside the keyway of the elevator sleeve 110, which prevents rotation of the tube 113 relative to the sleeve 110 (and thus also prevents further clockwise rotation of the elevator screw 111 because of the engagement of the pin 112). At this point, continued rotation of the drive screw 108 causes the elevator screw 111 (along with the elevator sleeve 110 and elevator tube 113) to be raised by the threaded engagement between the external threads of the drive screw 108 and the internal threads at the lower portion of the elevator screw 111. The key way of the elevator sleeve 110 is also received in a corresponding keyway of the case sleeves 107, which acts as an anti-rotation feature between those components. Thus, the case sleeve 107, the elevator sleeve 110, and the elevator tube 113 extend linearly without rotating, while the screws 108 and 111 internally provide the rotational and linear movement in order to enable the screw jack to both vertically expand and retract. Once the elevator screw 111 reaches its maximum height, the drive screw pin 109 is engaged with the internal threads of the elevator screw 111. The drive screw pin 109 prevents the elevator screw 111 from further travel and dislodging.

Sitting atop of the elevator tube 113 is the load rest 114. The load rest 114 is capable of engaging with a load such as the bumper of the vehicle or axle or other vehicle components such as the vehicle's frame (often called a jack point). The screw jack could then either raise or lower a vehicle depending on which direction the user turns the pinion gear 102 being in either the clockwise or counterclockwise direction respectively.

The lowering process is similar to the raising process but in reverse. From the screw jack's peak height, the user would turn the pinion gear 102 using the appropriate tools counterclockwise to initiate descent. This causes the drive screw 108 to also turn counterclockwise. The drive screw 108 then engages with the threads of the elevator screw 111 and, thus initiates the lowering of the elevator screw 111. As the counterclockwise rotation lowers the elevator screw 111, the elevator tube 113 remains in its extended position. Once the elevator screw 111 reaches the drive gear 105 (its lowest point), it cannot go any lower and thus rotates with the drive gear 105 and drive screw 108 in the counterclockwise direction. The elevator screw 111 then rotates along with the drive gear 105 and begins to lower the elevator tube 113, telescopingly. The elevator tube 113 continues to descend until it also hits the drive gear 105 and can no longer be turned lower, configuring the screw jack to be fully retracted and at its minimum height.

A label 115 is fixated on the front of the case sleeve 107 in order to afford the user with further guidance and safety precautions.

The particular order of components extending is not intended to be limiting. The internal design could alternatively be configured such that the elevator sleeve 110 is extended initially, and then the elevator tube 113 is extended thereafter (and the reverse may happen during lowering).

The three stopping points are strategically placed in order to prevent a potential breakage point among the screw jack's internal mechanisms. The three stops, comprised of the first stop 119, second stop 120, and third stop 121, of the elevator sleeve 110 travel through the three respective stop channels of the case sleeve 107, comprised of the first stop channel 116, second stop channel 117, and third stop channel 118, as the elevator sleeve 110 moves through the case sleeve 107 until the three stops reach their respective stopping points. The stopping points are where the three stop channels of the case sleeve 107 meet with the three stops of the elevator sleeve 110 at the upper ends of the channels. The three stops are engaged once the elevator sleeve 110 reaches its maximum height at which the three stops lock in place in order to perform their desired function.

The at least three stops are strategically defined on the bottom surface of the upper end walls of channels 116, 117, and 118 formed in the outer wall of the case sleeve 107. This provides optimal support for stops and channels to be engaged in order to prevent a bending moment from occurring.

The at least three stops and the channel placement around the perimeter of the sleeves is also strategic in order to prevent further disengagement as well. For example, the at least three stops and channels may be equally spaced apart along the outer perimeter of the sleeves. This spacing may afford further support in order to balance out the load, prevent the stops and channels from potentially disengaging, and/or prevent the stops from popping out from their respective channels.

The strategic placement of the end walls of the channels 116, 117, 118 in axially spaced relation sufficiently allows the overlapping axial regions of the bottom portion of sleeve 110 and the upper portion of sleeve 107, i.e., which overlap axially above the channels 116, 117, 118, to engage one another in the radial direction. That is, the upper ends of the channels 116, 117, 118 are spaced axially below the upper edge of the case sleeves 107, which provides an upper section thereabove free from the channels 116, 117, 118 that remains telescopingly engaged within the lower part of the elevator sleeve 110. This provides additional support against deflection in all radial directions. Preferably the axial spacing is between 5 and 20 mm, more preferably between 7 and 15 mm, and in the illustrated embodiment is about 8 mm, e.g., 8.1 mm. The upper surfaces of the stops 119, 120, 121 may also be spaced above the lower end of the elevator sleeve 110, which may also increase the engagement between the sleeves 107, 110. That distance may be, for example, in the range of 1-6 mm, such as 4.5 mm. As a non-limiting example, where the distance between the upper end of the case sleeve 107 to the upper ends of the channels 116, 117, 118, and specifically the downwardly facing surface at the upper end, is 8.1 mm and the distance between the lower end of the elevator sleeve 110 and the upper surface of the stops 119, 120, 121 is 4.5 mm, the total overlap is 13.6 mm. The axial length where the sleeves 107, 110 overlap in the fully extended position is selected to provide enough surface area contact among the screw jack's internal sleeves to prevent the screw jack from reaching a potential breaking point when a load is off axis and/or too heavy to support in addition to the support provided by the engagement of the stops 119, 120, 121 and the upper ends of the stop channels 116, 117, and 118. Further, this strategic placement affords the overlapping regions with some flexibility in the event that the load is too heavy and causes the screw jack to tilt. This limited flexibility may prevent a breakage or a snap when a bending moment may occur, unlike placement in the prior art where the stops are formed from the edges of the sleeves.

In some embodiments, the system may employ a plurality of telescoping case sleeves that has three case sleeves including a bottom, first case sleeve; a second elevator sleeve telescopingly receiving in the bottom, first case sleeve; and a top, third elevator tube telescoping received in the second elevator sleeve. The load rest may be mounted atop the top, elevator tube and the internally threaded shaft is an elevator screw that is also threaded externally. The top, elevator tube is internally threaded and meshed with the external threads of the elevator screw, such that rotation of the elevator screw raises and lowers the top, elevator tube.

In some embodiments, the elevator screw is internally threaded only at a lower end thereof, the third, elevator tube is internally threaded at only a lower end thereof. The drive screw may have a stop at an upper end thereof and the elevator screw may have a stop an upper end thereof, such that (a) as the drive screw is rotated to extend the case sleeves the elevator screw is driven upward by the drive screw until the stop on the drive screw engages an upper edge of the internal threading of the elevator screw which then rotatably drives the elevator screw to continue extending the third, elevator tube until the stop on the third, elevator tube engages an upper edge of the internal threading of the third, elevator tube and (b) as the drive screw is rotate to retract the case sleeves the drive screw rotates in an opposite direction to lower the elevator screw and rotate the drive screw to lower the third, elevator tube.

In some embodiments, the raising mechanism further comprises a plurality of elevator sleeves that vertically elevate and lower said elevator tube. For instance, the elevator sleeves may provide even greater support, if necessary, in order to raise the vehicle or load.

In some embodiments, at least three stop mechanisms comprise of at least three lances on a plurality of inner case sleeves and at least three guiding lances on a plurality of outer case sleeves.

In some embodiments, at least three of the stop mechanisms will retain the plurality of case sleeves on at least three locations equally spaced apart on the circumference of each case sleeve.

In some embodiments, the disclosure may be a method for retaining case sleeve resistance on a screw jack system comprising a raising mechanism that vertically elevates and lowers. The raising mechanism may comprise of a plurality of case sleeves to permit vertical elevation and at least three stop mechanisms to retain the plurality of case sleeves on at least three locations.

In some embodiments, the method for retaining case sleeve resistance on a screw jack system would include at least three stop mechanisms that comprise of at least three lances on an elevator sleeve and at least three guiding lances on a case sleeve.

In some embodiments, the method for retaining case sleeve resistance on a screw jack system would incorporate the at least three stop mechanisms to retain the plurality of case sleeves on at least three locations that are equally spaced apart on the diameter of each case sleeve.

The foregoing illustrated embodiment has been provided solely to illustrate the structural and functional principles of an embodiment of the invention and is not intended to be limiting. To the contrary, the present invention encompasses all modifications, alterations, substitutions, or equivalents within the spirit and scope of the following claims.

What is claimed is:

1. A screw jack system comprising:
a base;
a case body having a drive gear to provide rotational motion;
a rotational input for driving the drive gear;
a drive screw perpendicular to said drive gear and rotatable therewith to convert rotational motion into linear motion;
a plurality of telescoping sleeves extendible and retractable relative to one another to permit vertical elevation,
a raising and lowering mechanism within said sleeves for extending and lowering comprising an internally threaded shaft meshed with the drive screw such that rotation of the drive screw raises and lowers the internally threaded shaft linearly to extend and retract the sleeves relative to one another;
wherein a bottom, first one of the sleeves is connected to the base and wherein an upper portion of the bottom, first one of the case sleeves and a lower portion of a second one of the elevator sleeves telescopingly received in the bottom, first one each have at least three stop mechanisms configured to engage one another on at least three locations when said elevator sleeve is fully extended with respect to the bottom, case sleeve to retain the elevator sleeve against withdrawal from the first case sleeve; and
a load rest affixed atop said plurality of sleeves for engagement under a vehicle.

2. The system of claim 1, wherein the plurality of telescoping sleeves has three sleeves including the bottom, first case sleeve, the second elevator sleeve telescopingly receiving in the bottom, first case sleeve, and a top, third elevator tube telescopingly received in the second elevator sleeve, the load rest being mounted atop the top, third elevator tube; and
wherein the internally threaded shaft is an elevator screw that is also threaded externally and the top, third elevator tube is internally threaded and meshed with the external threads of the elevator screw, such that rotation of the elevator screw raises and lowers the top, third elevator tube.

3. The system of claim 2, wherein the elevator screw is internally threaded only at a lower end thereof, the third, elevator tube is internally threaded at only a lower end thereof, the drive screw has a stop at an upper end thereof and the elevator screw has a stop an upper end thereof, such that (a) as the drive screw is rotated to extend the sleeves the elevator screw is driven upward by the drive screw until the stop on the drive screw engages an upper edge of the internal threading of the elevator screw which then rotatably drives the elevator screw to continue extending the third, top elevator tube until the stop on the third, top elevator tube engages an upper edge of the internal threading of the third, top case sleeve, and (b) as the drive screw is rotate to retract the sleeves the drive screw rotates in an opposite direction to lower the elevator screw and rotate the drive screw to lower the third, top elevator tube.

4. The system of claim 3, wherein each stop is a drive pin.

5. The system of claim 1, wherein the raising mechanism further comprises a plurality of elevator sleeves that vertically elevate and lower said elevator tube.

6. The system of claim 1, wherein at least three stop mechanisms comprise at least three lances on a plurality of inner case sleeves and at least three guiding lances on a plurality of outer case sleeves.

7. The system of claim 1, wherein the at least three stop mechanisms retain said plurality of case sleeves on at least three locations equally spaced apart on the circumference of each case sleeve.

8. A method for retaining case sleeve resistance on a screw jack system comprising a raising mechanism that vertically elevates and lowers, wherein said raising mechanism comprises a plurality of case sleeves to permit vertical elevation and at least three stop mechanisms to retain said plurality of case sleeves on at least three locations.

9. The method of claim 5, wherein at least three stop mechanisms comprise at least three lances on an inner case sleeve and at least three guiding lances on an outer case sleeve.

10. The method of claim 5, wherein the at least three stop mechanisms retain said plurality of case sleeves on at least three locations equally spaced apart on the diameter of each case sleeve.

11. The system of claim 1, wherein the stop mechanisms on the bottom, first sleeve are spaced axially below an upper edge of the bottom, first case sleeve, such that when fully extended a bottom portion of the second case sleeve and an upper portion of the first case sleeve overlap axially.
